(19) United States
(12) Patent Application Publication
(10) Pub. No.: US 2006/0098829 A1
(43) Pub. Date: May 11, 2006

(54) Bone conduction device

(76) Inventor: Kazuji Kobayashi, Tokyo (JP)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/548,517

(22) PCT Filed: Mar. 10, 2004
(86) PCT No.: PCT/JP04/03109

§ 371 Date: Sep. 7, 2005

(30) Foreign Application Priority Data
Mar. 11, 2003 (JP) 2003-065257

(51) Int. Cl. H04R 25/00

(52) U.S. Cl. 381/151

(57) ABSTRACT

A bone conduction device which, when particularly employed in the receiver of a bone conduction telephone, is capable of obtaining a sufficient amount of sound as to not only a bone conduction sound but also an aerial vibration sound to ensure clear reception of the sound. The bone conduction device comprises a bone conduction device unit and a case receiving the device unit therein to serve as a vibration section and is characterized in that a compliance increasing means, such as a corrugation, is disposed along the peripheral edge of the vibrating surface of the case having the bone conduction device unit fixed thereto.

### TECHNICAL FIELD

The present invention relates to a bone conduction device, and more particularly to a bone conduction speaker or a bone conduction microphone, wherein the bone conduction device is capable of keeping “loudness”, which is the properties of sound in volume of the device even when the bone conduction device is not held in abutting contact with the head portion of a user in use of a telephone set and like instruments in which the bone conduction device is incorporated.

### BACKGROUND ART

For example, a bone conduction speaker is constructed of a bone conduction speaker unit 21 and a case 22 in which the speaker unit 21 is packaged. The speaker unit 21 is constructed of: a doughnut-shaped voice coil 24; a magnet 25 disposed on an inner peripheral surface of a peripheral wall 27 in a peripheral edge portion of a yoke 26; a vibrating plate 28 mounted on an upper surface of the peripheral wall 27; and, a vibrating block 29 fixedly mounted on an upper surface of the vibrating plate 28. The bone conduction speaker unit 21 has the vibrating block 29 thereof fixedly mounted on a ceiling surface in the inside of the case 22 through a screw 30 and like fastening means, so that the speaker unit 21 is disposed inside the case 22 in construction (FIG. 4).

In such a construction, when the vibrating plate 28 vibrates, the case's vibrating surface on which the vibrating plate 28 is fixedly mounted through the vibrating block 29 also vibrates. Due to this, it is possible for a user, even when the user is of advanced aged or has difficulty in hearing, to clearly catch the sound by bringing the case's vibrating surface into abutting contact with his or her head portion at the side thereof behind the ear, or at the cheek or the forehead of the head portion of the user so as to catch the sound as a bone conduction sound.

In the bone conduction speaker, which has such a construction and is built in a telephone set, when the case's vibrating surface is separated from the user's head portion, vibrations of the case's vibrating surface are then transmitted through air in the form of aerial vibrations, and become audible to the user through his or her eardrum just like ordinary sounds. Consequently, in case that people without disabilities use the bone conduction telephone set of this type, it is possible for the people without disabilities to avoid employing a cumbersome method, which forces the people without disabilities to keep the case's vibrating surface in a butting contact with their head portions in use, by employing the alternative method to the cumbersome method, in which alternative method a receiver of the telephone set is disposed in the vicinities of their ears. However, heretofore, it is not possible for such alternative method to obtain a sufficient amount of aerial vibrations. Due to this, the problem lies in that the alternative method is poor in “loudness” (i.e., the properties of sound in volume).

### DISCLOSURE OF THE INVENTION

Since the conventional bone conduction speaker suffers from the above-mentioned problem, it is an object of the present invention to provide a bone conduction speaker, which is free from the problem inherent in the conventional bone conduction speaker. More particularly, it is an object of the present invention to provide a bone conduction speaker, which is capable of producing a sufficient amount of sound volume with respect to not only a bone conduction sound itself but also aerial vibrations when the bone conduction speaker is employed in a receiver of a bone conduction telephone set, thereby allowing the user to clearly catch the sound.

The present invention solves the above problem by providing a bone conduction device, which comprises: a bone conduction device unit; and, a case which receives the device unit therein to form a vibrating portion, and is characterized in that a compliance increasing means is so disposed as to extend along by a peripheral edge portion of a vibrating surface of the case, wherein the bone conduction device unit is fixedly mounted on the vibrating surface of the case.

In general, the compliance increasing means is constructed of a corrugation. In this case, the corrugation may be a part of multiple-part corrugations.

Further, the compliance increasing means may be constructed of an elastic member. The elastic member may be different in material from the vibrating surface and disposed in the vibrating surface as a separate member.

The compliance increasing means in the vibrating surface of the case may have its inner side formed into a spherical shape. Further, the case may be constructed of a case of a telephone set.

### BRIEF DESCRIPTION OF THE DRAWING

FIG. 1 is a longitudinal sectional view of an embodiment of the bone conduction device (speaker) of the present invention.

FIG. 2 is an enlarged longitudinal sectional view of anther embodiment of the bone conduction device (speaker) of the present invention, illustrating an essential portion of the embodiment.

FIG. 3 is a graph illustrating a difference in lowest resonance frequency between the case where the compliance increasing means is provided and the other case where the compliance increasing means is not provided.

FIG. 4 is a longitudinal sectional view of an example of the conventional bone conduction speaker.

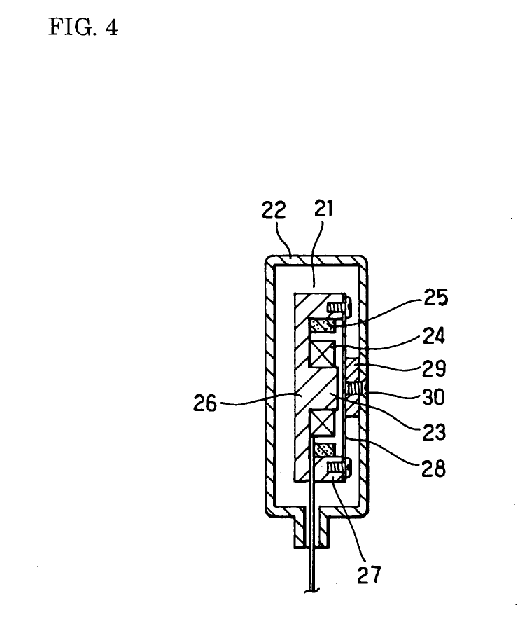

### BEST MODE FOR CARRYING OUT THE INVENTION

With reference to the accompanying drawings, embodiments of the present invention will be described. A bone conduction device of the present invention comprises a bone conduction speaker and a bone conduction microphone, both of which are substantially the same in construction. Due to this, only the bone conduction speaker will be described hereinbelow.

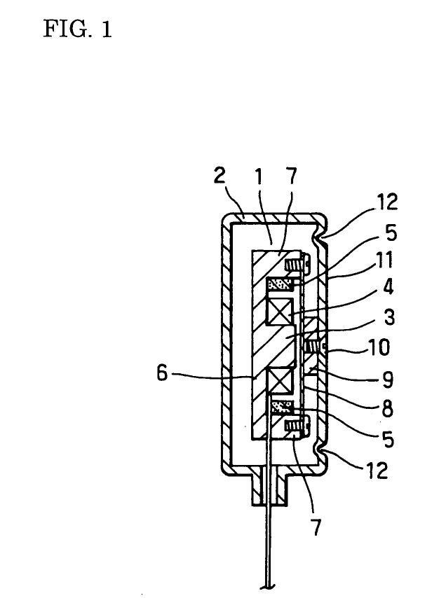

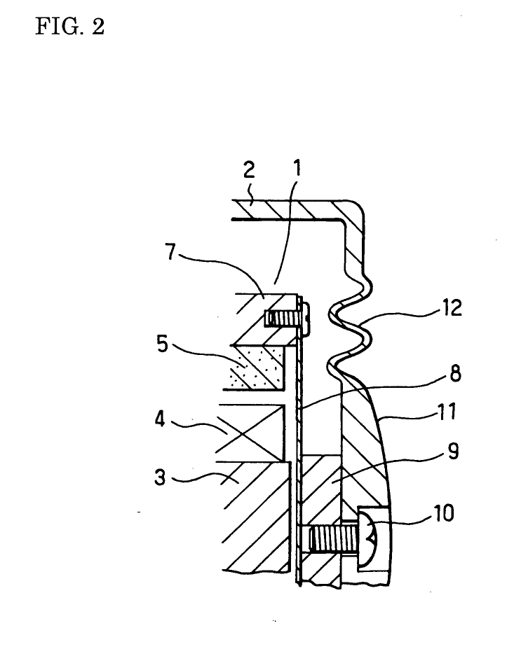

FIG. 1 is a longitudinal sectional view of an embodiment of the bone conduction speaker of the present invention. FIG. 2 is an enlarged longitudinal sectional view of anther embodiment of the bone conduction speaker of the present invention, illustrating an essential portion of the embodiment. The bone conduction speaker of the present invention is constructed of a bone conduction speaker unit 1 and a case 2 for packaging the speaker unit 1 therein.

In general, the speaker unit 1 is constructed of: a doughnut-shaped voice coil 4, which surrounds a central magnetic pole 3; a magnet 5 disposed on an inner peripheral surface of a peripheral wall 7 in a peripheral edge portion of a yoke 6; a vibrating plate 8 mounted on an upper surface of the peripheral wall 7; and, a vibrating block 9 fixedly mounted on an upper surface of the vibrating plate 8. The bone conduction speaker unit 1 has the vibrating block 9 thereof fixedly mounted on a ceiling surface located in the inside of the case 2 through a screw 10 and like fastening means, so that the speaker unit 1 is disposed inside the case 2 in construction

The above-mentioned construction is of a so-called “outer magnet” type unit. In contrast with this type, it is also possible for the unit 1 to employ a so-called “inner magnet” type construction, in which the magnet 5 is disposed inside the voice coil 4.

A corrugation 12, which is small in thickness, is formed along a peripheral edge portion of a surface that is the vibrating surface 11 of the case 2, on which surface the vibrating block 9 is fixedly mounted. This corrugation 12 is a single corrugation as shown in FIG. 1, and functions to adequately increase in “compliance” of the vibrating surface 11 (the term “compliance” is defined as the reciprocal of the stiffness). Shown in FIG. 2 are double corrugations, which may be used in place of the single corrugation 12. The number of these corrugations may be further increased if necessary. Furthermore, it is also possible to use an elastic member in place of the thin-thickness corrugation 12, which is different in material from the vibrating surface 11 and disposed in the vibrating surface 11 as a separate member.

In the case where a person with difficulty in hearing uses a telephone set which employs the bone conduction speaker having the above construction in its receiver portion, it is necessary for the person with difficulty in hearing to hold the receiver of the telephone set in abutting contact with the ear in his or her head portion or in the vicinities of the ear of the head portion. In such a case, it is possible to neglect in mass both of the case 2 and the vibrating plate 8 in comparison with the mass of the head portion of the person. Due to this, a lowest resonance frequency f₀, which determines a lower sound limit of the speaker, is determined by: an effective mass M of a vibrating system comprising the voice coil 4, magnet 5 and the yoke 6; and, a compliance C of the vibrating plate 8 which is an element for supporting the above-mentioned vibrating system (see Equation 1).
f₀=1/(2π√M·√C) [Equation 1]

Incidentally, it is necessary to limit in value the compliance C of the vibrating plate 8 to an appropriate small level in order to ensure variation in magnetic flax in a gap between the vibrating plate 8 and the central magnetic pole 3, and further to ensure a sufficient stiffness of the vibrating plate 8 for keeping the above-mentioned gap against the weight of the bone conduction speaker unit 1. As a result, it is natural that the vibrating plate 8 is not capable of obtaining sufficient amplitude, and therefore has its frequency “f₀” kept at a relatively high level.

Further, even in the case where the person without disabilities use the above-mentioned telephone set without bringing its receiver into abutting contact with their head portions, the receiver is still held by hands of the person. Due to this, the Equation 1 is also applicable in this case where: since the corrugation 12 provides a compliance C_{c}, the lowest resonance frequency f_{0c} may be kept at a low level (see Equation 2) and thereby permitting the inner area of the corrugation 12 to obtain a sufficient amplitude, which results in an improvement in the properties of sound pressure frequency. Due to this, a sufficient sound wave is easily issued from the bone conduction speaker to enable the person to obtain a sufficient amount of sound volume.
f_{0c}=1/(2π√M·√(C+C_{c})) [Equation 2]

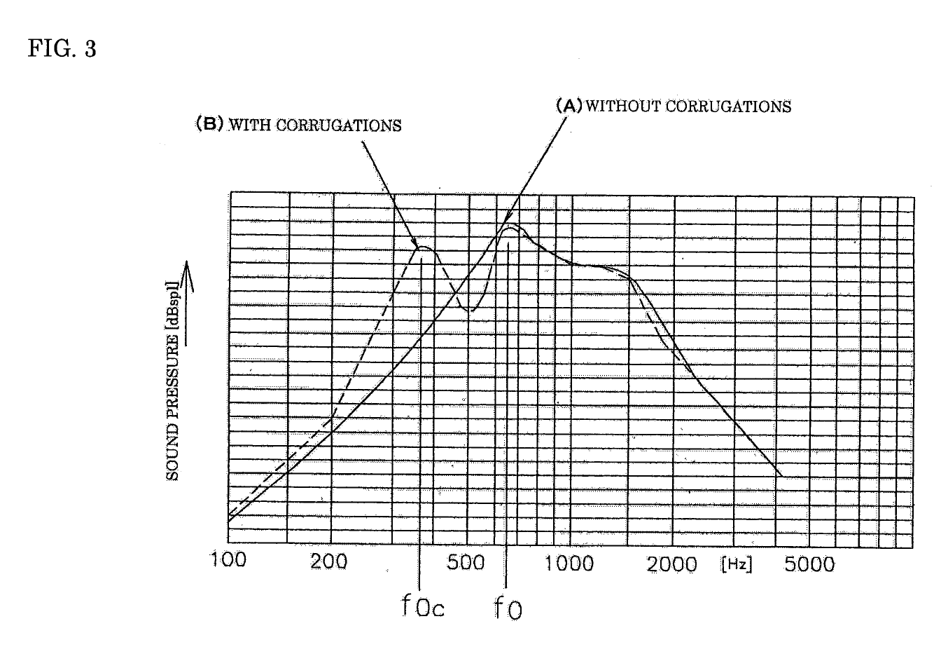

FIG. 3 is a graph, in which: the case (A) where the lowest resonance frequency f₀ of the bone conduction speaker is not provided with the corrugation 12 is compared with the other case (B) where the lowest resonance frequency f_{0c} of the bone conduction speaker is provided with the corrugation 12, illustrating observed data. In comparison with the case (A), it is recognized that the other case (B) according to the present invention is lower in lowest resonance frequencies.

In a cellular phone and like telephone sets which are required to be downsized in both volume and weight, an effective mass M of the members thereof comprising the voice coil 4, magnet 5 and the yoke 6 is small. Due to this, such a telephone set tends to keep its fundamental frequency in a relatively high frequency range. Consequently, in this case, an additional compliance derived from the provision of the corrugation 12 is particularly effective.

Incidentally, although the case 2 is constructed of a case of the speaker itself, it is also possible that the case 2 is constructed of a case of the telephone set. In the latter case, since the vibrating portion of the telephone set may be formed independently of the remaining members, the latter case is advantageous in this respect.

In anyone of the embodiments described above, it is preferable to form the corrugation 12 or the elastic member, which is the alternative to the corrugation 12, into a slightly projecting spherical shape (see FIG. 2). Such a spherical shape makes it easy to bring the vibrating surface 11 into abutting contact with the head portions of the users.

### INDUSTRIAL APPLICABILITY

The present invention has a construction described in the above. Due to this, in the bone conduction device of the present invention, particularly, in the bone conduction speaker of the present invention employed in the receiver of the bone conduction telephone set, it is possible for the user to obtain a sufficient amount of the sound volume in each of the bone conduction sound and the aerial sounds, which ensures the user to be free from difficulties in hearing. It is also possible to directly apply the same construction of the bone conduction speaker described above to a bone conduction microphone.

1. A bone conduction device comprising: a bone conduction device unit; and, a case which receives said device unit therein to form a vibrating portion, comprising: a compliance increasing means is so disposed as to extend along by a peripheral edge portion of a vibrating surface of said case, wherein said bone conduction device unit is fixedly mounted on said vibrating surface of said case.

2. The bone conduction device as set forth in claim 1, wherein said compliance increasing means is constructed of a corrugation.

3. The bone conduction device as set forth in claim 2, wherein said corrugation is a part of multiple-part corrugations.

4. The bone conduction device as set forth in claim 1, wherein: said compliance increasing means is constructed of an elastic member; and, said elastic member is different in material from said vibrating surface and disposed in said vibrating surface.

5. The bone conduction device as set forth in claim 1, wherein said compliance increasing means in said vibrating surface of said case has its inner side formed into a spherical shape.

6. The bone conduction device as set forth in claim 1, wherein said case is constructed of a case of a telephone set.

7. The bone conduction device as set forth in claim 1, wherein the bone conduction device takes the form of either a bone conduction speaker or a bone conduction microphone.

8. The bone conduction device as set forth in claim 2, wherein said compliance increasing means in said vibrating surface of said case has its inner side formed into a spherical shape.

9. The bone conduction device as set forth in claim 3, wherein said compliance increasing means in said vibrating surface of said case has its inner side formed into a spherical shape.

10. The bone conduction device as set forth in claim 4, wherein said compliance increasing means in said vibrating surface of said case has its inner side formed into a spherical shape.

11. The bone conduction device as set forth in claim 2, wherein the bone conduction device takes the form of either a bone conduction speaker or a bone conduction microphone.

12. The bone conduction device as set forth in claim 3, wherein the bone conduction device takes the form of either a bone conduction speaker or a bone conduction microphone.

13. The bone conduction device as set forth in claim 4, wherein the bone conduction device takes the form of either a bone conduction speaker or a bone conduction microphone.

14. The bone conduction device as set forth in claim 5, wherein the bone conduction device takes the form of either a bone conduction speaker or a bone conduction microphone.

15. The bone conduction device as set forth in claim 6, wherein the bone conduction device takes the form of either a bone conduction speaker or a bone conduction microphone.

16. The bone conduction device as set forth in claim 8, wherein the bone conduction device takes the form of either a bone conduction speaker or a bone conduction microphone.

17. The bone conduction device as set forth in claim 9, wherein the bone conduction device takes the form of either a bone conduction speaker or a bone conduction microphone.

18. The bone conduction device as set forth in claim 10, wherein the bone conduction device takes the form of either a bone conduction speaker or a bone conduction microphone.

19. The bone conduction device as set forth in claim 11, wherein the bone conduction device takes the form of either a bone conduction speaker or a bone conduction microphone.
